(19) United States
(12) Patent Application Publication
(10) Pub. No.: US 2014/0241976 A1
(43) Pub. Date: Aug. 28, 2014

(54) PROCESS FOR THE PRODUCTION OF CHLORINE USING A CERIUM OXIDE CATALYST IN AN ISOTHERMIC REACTOR

(71) Applicant: Bayer Intellectual Property GmbH, Monheim (DE)

(72) Inventors: Timm Schmidt, Neuss (DE); Aurel Wolf, Wulfrath (DE); Oliver Felix-Karl Schlüter, Leverkusen (DE); Thomas Westermann, Koln (DE); Cecilia Mondelli, Zurich (CH); Javier Perez-Ramirez, Zurich (CH); Hary Soerijanto, Berlin (DE); Reinhard Schomäcker, Berlin (DE); Detre Tescher, Mahlow (DE); Robert Schlögl, Berlin (DE)

(21) Appl. No.: 14/130,558

(22) PCT Filed: Jul. 2, 2012
(86) PCT No.: PCT/EP2012/062807

§ 371 Date: Mar. 25, 2014

(30) Foreign Application Priority Data
Jul. 5, 2011 (EP) 11172623.8

(51) Int. Cl. C01B 7/04

(52) U.S. Cl. CPC C01B 7/04
USPC 423/502

(57) ABSTRACT

A process for the production of chlorine by thermo-catalytic gas phase oxidation of hydrogen chloride gas with oxygen, in the presence of a catalyst, and separation of the chlorine from the reaction products comprising chlorine, hydrogen chloride, oxygen and water, characterized in that
a) a cerium oxide is used as catalytically active component in the catalyst and
b) the reaction gases are converted at the cerium oxide catalyst in one or more isothermic reaction zones, preferably in one or more tube bundle reactors,
   wherein the molar O₂/HCl-ratio is equal or above 0.75 in any part of the cerium oxide containing reaction zones.

The present invention relates to a process for the production of chlorine by thermo-catalytic gas phase oxidation of hydrogen chloride gas with oxygen, in the presence of a catalyst, and separation of the chlorine from the reaction products comprising chlorine, hydrogen chloride, oxygen and water, characterized in that
a) a cerium oxide is used as catalytically active component in the catalyst and
b) the reaction gases are converted at the cerium oxide catalyst in one or more isothermic reaction zones, preferably in one or more tube bundle reactors,
   wherein the molar O₂/HCl-ratio is equal or above 0.75 in any part of the cerium oxide containing reaction zones.

The catalytic oxidation of hydrogen chloride with oxygen in an exothermic equilibrium reaction was developed by DEACON in 1868 and constituted the first industrial route for chlorine production:

4 HCl+O₂→2 Cl₂+2 H₂O

However, the Deacon process was pushed severely into the background with the introduction of the chlor-alkali industry. Virtually the entire production of chlorine was by electrolysis of aqueous sodium chloride solutions (Ullmann Encyclopedia of Industrial Chemistry, seventh release, 2006). However, the Deacon process has recently attracted renewed interest, since the worldwide demand for chlorine is growing faster than the demand for sodium hydroxide solution. The process for the preparation of chlorine by oxidation of hydrogen chloride, which is unconnected with the preparation of sodium hydroxide solution, can support this demand. Furthermore, hydrogen chloride is obtained as a linked product in large quantities, for example, in phosgenation reactions, as in the preparation of isocyanates.

The first catalysts for oxidation of hydrogen chloride contained copper in chloride or oxide form as the active component and were already described by Deacon in 1868. These catalysts were shown to rapidly deactivate as a consequence of volatilization of the active phase at the high operational temperatures.

The oxidation of hydrogen chloride with catalysts based on chromium oxide is known. However, chromium catalysts are prone to form chromium (VI) oxide under oxidizing conditions, which is a very toxic substance. Also a short catalyst lifetime is assumed in other publications (WO 2009/035234 A, page 4, line 10).

First catalysts for the oxidation of hydrogen chloride containing ruthenium as the catalytically active component were described in 1965. Such catalysts were, starting from RuCl₃ for example, supported on silicon dioxide and aluminum oxide (DE 1567788A1). However, the activity of the RuCl₃/SiO₂ catalysts was very low. Further Ru-based catalysts with the active mass of ruthenium oxide, ruthenium mixed oxide or ruthenium chloride and various oxides, such as e.g., titanium dioxide, zirconium dioxide, tin oxide etc., as the support material has also been described (EP 743277A1, U.S. Pat. No. 5,908,607, EP 2026905A1, and EP 2027062A2). In such catalysts, the content of ruthenium oxide is generally 0,1 wt. % to 20 wt. %.

The ruthenium-based catalysts have a quite high activity and stability at temperatures up to 350-400° C. But the stability of ruthenium-based catalysts at temperatures above 350-400° C. is still not proven (WO 2009/035234 A2, page 5, line 17). Furthermore, the platinum group element ruthenium is highly expensive, very rare and the world market price is unsteady, thus making commercialization of such a catalyst difficult.

Cerium oxide catalysts for the thermo-catalytic HCl-oxidation are known from DE 10 2009 021 675 A1 and WO 2009/035234 A2. In both patent applications similar cerium oxide catalyst systems are described. WO 2009/035234 A2 speculates about the stability of cerium oxide catalysts (page 8, line 4) without providing adequate examples (only 2 h time on stream). The catalysts are preferably applied at temperatures below 400° C. (page 12, line 23) and in particles of 100 nm to 100 μm size (page 12, line 1), preventing overheating of the catalyst by the exothermic reaction (page 12, line 3), which is indicative of the use in a fluidized bed. DE 10 2009 021 675 A1 speculates about possible reaction conditions for a cerium oxide catalyst ([0058] or claim 15: “the volume ratio of HCl to oxygen is preferably in the range of 1:1 to 20:1, more preferably in the range of 2:1 and 8:1 and even more preferably in the range of 2:1 and 5:1”), indicating that even a stoichiometric amount or even excess of HCl is most preferable. DE 10 2009 021 675 also speculates about the possible implementation in a tube bundle reactor ([0051]), without providing adequate examples to prove these speculations. Consequently, there is still a lack of knowledge regarding how to apply the known cerium oxide catalysts to known reaction systems reaching a long-term stable and cost-efficient production of chlorine from HCl and oxygen.

Accordingly one object of the present invention is to provide a catalytic reaction process for the long-term stable and cost-efficient production of chlorine from HCl and oxygen.

Surprisingly, it has been found that this object can be achieved by applying a known cerium oxide catalyst to a known isothermal reactor setup, wherein the molar O₂/HCl ratio is equal or above 0.75 in any part of the cerium oxide containing reaction zones. Surprisingly a molar O₂/HCl ratio equal or above 0.75 is necessary, since the cerium oxide catalyst drastically deactivates at lower O₂/HCl ratios, presumably due to the formation of CeCl₃.6H₂O or CeCl₃.

Subject matter of the invention is a process for the production of chlorine by thermo-catalytic gas phase oxidation of hydrogen chloride gas with oxygen, in the presence of a catalyst, and separation of the chlorine from the reaction products comprising chlorine, hydrogen chloride, oxygen and water, characterized in that
a) a cerium oxide is used as catalytically active component in the catalyst and
b) the reaction gases are converted at the cerium oxide catalyst in one or more isothermic reaction zones, preferably in one or more tube bundle reactors,
   wherein the molar O₂/HCl-ratio is equal or above 0.75 in any part of the cerium oxide containing reaction zones.

In a preferred embodiment, the molar O₂/HCl-ratio is equal or above 1 in any part of the cerium oxide containing reaction zones. In a more preferred embodiment, the molar O₂/HCl-ratio is equal or above 1.5 in any part of the cerium oxide containing reaction zones. In an even more preferred embodiment, the molar O₂/HCl-ratio is equal or above 2 in any part of the cerium oxide containing reaction zones. The O₂/HCl-ratio throughout this description is understood as molar O₂/HCl-ratio.

It is well known to the educated expert that in case of exothermic reactions the gas temperature of the educt/product mixture in tube bundle or fluidized bed reactors under typical operating conditions are neither identical to the cooling advice and/or media nor identical in all parts of the respective reaction zone. Typically a temperature gradient in the direction of the cooling advice and/or media is existent. The point or several points with maximum temperature in a reaction zone or a reaction sub zone are typically called hot spot(s). It is understood that isothermal operation in the sense of the present invention means that hotspot formation is controlled by cooling sufficiently. Preferably the cooling is sufficient that the maximum gas temperature in a reaction zone is at last 100K above the average gas temperature in the same reaction zone, more preferably the cooling is sufficient that the maximum gas temperature in a reaction zone is at last 50K above the average temperature in the same reaction zone.

In a preferred embodiment of the invention, the process is carried out in only a single isothermal reactor, in particular an isothermal tube bundle reactor is used in the process in the direction of flow of the reaction gases.

A tube bundle reactor according to the invention is preferably divided into 2-10 reaction zones. A preferred embodiment of the process is therefore characterized in that the isothermic reactors comprise at least two, preferably 2 to 10 different reaction zones, which are connected in series.

In a more preferred embodiment, 2-5 reaction zones are applied. In an even more preferred embodiment, 2-3 reaction zones are applied. A “reaction zone” is understood to be as one logic part of a tube bundle reactor in the direction of flow.

In a preferred embodiment, the temperature in a reaction zone is controlled by a plurality of surrounding cooling chambers, where a cooling media flows through. Even more preferably, each reaction zone is surrounded by one cooling chamber, where a cooling media flows through. A suitable isothermal tube bundle reactor is discussed in “Trends and Views in the Development of Technologies for Chlorine Production from Hydrogen Chloride”, SUMITOMO KAGAKU 2010-II, by Hiroyuki ANDO, Youhei UCHIDA, Kohei SEKI, Carlos KNAPP, Norihito OMOTO and Masahiro KINOSHITA.

Preferably, the reaction temperature is changed from at least one reaction zone to the next reaction zone, i.e. targeting a suitable temperature profiling in the direction of flow. A preferred process is hence characterized in that different reaction zones are provided which are operated at a different reaction temperature.

Also preferably, the catalyst activity is changed from at least one reaction zone to the next reaction zone, i.e. targeting a suitable activity profiling in the direction of flow. Another preferred embodiment of the new process is then characterized in that the different reaction zones are operated using catalyst material having a different catalyst activity in different reaction zones. A particular preferred embodiment of the invention is a process which is characterized in that the different reaction zones are operated using catalyst material having different catalysts with different catalytically active components in the catalyst.

More preferably, both measures (different reaction zones with different temperature profile and different catalyst activity) are combined. Different temperatures in the different reaction zones are realized e.g. by adjusting the cooling effort to the heat of reaction. Suitable reactor setups are described in e.g. EP 1 170 250 B1 and JP 2004099388 A, respectively. A temperature profiling and/or activity profiling can help to control the position and the strength of hot spots in the catalyst beds.

In a preferred embodiment, the average temperature in all cerium oxide catalyst containing reaction zones is kept in the range of from 250 to 600° C. In a more preferred embodiment, the average temperature in all cerium oxide catalyst containing reaction zones is kept in the range of from 300 to 550° C. In an even more preferred embodiment, the average temperature in all cerium oxide catalyst containing reaction zones is kept in the range of from 350 to 500° C. Significantly below 250° C. the activity of the cerium oxide catalyst is very low. Significantly above 500° C. typically applied nickel based materials of construction are not long-term stable against the reaction conditions.

In a preferred embodiment, the outlet reaction gas temperature in the last reaction zone is kept at equal or below 450° C. In a more preferred embodiment, the outlet reaction gas temperature in the last reaction zone is kept at equal or below 420° C. More preferably, the outlet temperature in the last reaction zone is lower than the average temperature in at least one other cerium oxide catalyst containing reaction zone. It is in some cases advantageous to lower the outlet temperature in the last reaction zone to shift the equilibrium of the reaction to the products, thus enabling higher HCl conversion. On the other hand, the average temperature in all other reaction zones should be as high as possible, limited by unfavorable hotspot formation, the stability of construction materials and the equilibrium, to improve cerium oxide utilization.

In a preferred embodiment, the pressure of the reaction part is in the range of 2 to 10 bar (2000 to 10000 hPa), more preferably in the range of 3 to 7 bar (3000 to 7000 hPa).

In a preferred embodiment, a catalyst is used comprising ruthenium metal and/or ruthenium compounds and cerium oxide as catalytically active components. A particular preferred process is characterized in that at least two different types of catalysts are present in different reaction zones, wherein a first type of catalyst comprises ruthenium metal and/or ruthenium compounds as catalytically active component and a second type of catalyst comprises cerium oxide as catalytically active component.

Preferably the ruthenium-based catalyst is applied in a temperature range of 200 to 450° C., whereas the cerium oxide catalyst is applied in a temperature range of 300 to 600° C., if such a combination is used. Another preferred process is therefore characterized in that the ruthenium-based catalyst is applied in a reaction zone which is kept at a gas temperature in the range of from 200 to 450° C., and that the cerium oxide catalyst is applied in a a reaction zone which is kept at a gas temperature in the range of from 300 to 600° C.

More preferably the ruthenium-based catalyst is applied in a temperature range of 250 to 400° C., whereas the cerium oxide catalyst is applied in a temperature range of 350 to 500° C., if such a combination is used.

In a preferred embodiment, at least one reaction zone contains a cerium oxide catalyst and at least the last reaction zone contains a ruthenium-based catalyst. Hence a process is particularly preferred, which is characterized in that different reaction zones connected in series are used for the reaction, wherein at least one reaction zone comprises a cerium oxide based catalyst and at least the last reaction zone comprises a ruthenium-based catalyst. More preferably, at least one reaction zone contains a cerium oxide catalyst and the last reaction zone contains a ruthenium-based catalyst.

In an optional embodiment, a so called split HCl-injection is applied, i.e. not the total HCl amount to be converted is fed into the first reaction zone, but also into later reaction zones.

In a preferred embodiment, the temperature in one or more reaction zones is increased, if the catalyst deactivates.

In a preferred embodiment the initial activity of the cerium oxide catalyst is partly restored by a short treatment with higher O₂/HCl-ratio than under regular operation conditions, more preferably inside the reactor(s). Thus the preferred variant of the new process is characterized in that during operation of the process the initial activity of the cerium oxide catalyst is restored by raising the ratio of O₂/HCl, preferably by lowering the amount of HCl, particularly preferred raising the ratio of O₂/HCl to the double, and particularly keeping the raised ratio of O₂/HCl for a period of about at least half an hour and then returning to the previous ratio of O₂/HCl.

Preferably, the O₂/HCl-ratio to partly restore the activity is equal or above 2, more preferably equal or above 5, even more preferably the HCl-feed is completely stopped (HCl/O₂=0). The time period to restore the activity is preferably equal or below 5 h, more preferably equal or below 2 h and even more preferably equal or below 1 h. The temperature range for partly restoring the initial activity is preferably approximately similar as described for regular operation.

In a preferred embodiment, the cerium oxide catalyst which is used in the process is pre-calcined at a temperature in the range of from 500° C. to 1100° C., more preferably in a temperature range of 700 to 1000° C. and most preferably at approximately 900° C. Preferably, calcination is carried out under air-similar conditions. The calcination period is preferably in the range of 0.5 to 10 h, more preferably approximately 2h. A pre-calcination improves the resistance of the catalyst against formation of CeCl₃.6H₂O or CeCl₃ phases and/or bulk chlorination, which is believed to be a significant catalyst deactivation cause.

In a preferred embodiment, the cerium oxide catalyst used does not exhibit X-ray diffraction reflections which are characteristic for CeCl₃.6H₂O or CeCl₃ phases during or after use. X-ray analysis is done according to example 10. The preferred variant of the process is then characterized in that a cerium oxide catalyst is used in the process which comprises no CeCl₃.6H₂O or CeCl₃ phases, and which in particular does not exhibit significant X-ray diffraction reflections which are characteristic for CeCl₃.6H₂O or CeCl₃ phases.

In another preferred embodiment, less than 3 theoretical layers of oxygen in the cerium oxide catalyst are exchanged by chlorine during or after use. Hence a process is preferred which is characterized in that cerium oxide catalyst used in the process will be subjected to a activity restoring treatment at increased molar O₂/HCl-ratio as described above or replaced by fresh catalyst if more than 3 theoretical layers of oxygen in the cerium oxide catalyst are exchanged by chlorine during use of the catalyst.

More preferably, less than 2 theoretical layers of oxygen in the cerium oxide catalyst are exchanged by chlorine during or after use. This is proven by nitrogen adsorption and X-ray photoelectron spectroscopy according to example 11.

Preferably, the cerium oxide catalyst and/or the ruthenium based catalyst are supported catalysts. Suitable support materials are silicon dioxide, aluminum oxide, titanium oxide, tin oxide, zirconium oxide, or their mixtures.

Preferably, the content of cerium oxide (calculated as CeO₂) is 1 to 30% of the total amount of the calcined catalyst. More preferably, the content of cerium oxide (calculated as CeO₂) is 5 to 25% of the total amount of the calcined catalyst. Even more preferably, the content of cerium oxide (calculated as CeO₂) is approximately 15% of the total amount of the calcined catalyst.

It is understood, that a supported or unsupported cerium precursor component catalyst could be also calcined in the reactor(s) even during the HCl oxidation operation to get the final cerium oxide catalyst, as it is described e.g. in DE 10 2009 021 675 A1, its disclosure being incorporated here by reference.

Suitable cerium oxide catalysts for the new process, their preparation and properties are generally known from DE 10 2009 021 675 A1, its disclosure being incorporated here by reference. Suitable ruthenium based catalysts for the new process, their preparation and properties are generally known from EP 743277 A1, U.S. Pat. No. 5,908,607, EP 2026905A1 or EP 2027062A2 their specific disclosure being incorporated here by reference.

The conversion of hydrogen chloride in a single pass can preferably be limited to 15 to 90%, preferably 40 to 90 particularly preferably 50 to 90%. Some or all of the unreacted hydrogen chloride can be recycled into the catalytic hydrogen chloride oxidation after being separated off.

The heat of reaction of the catalytic hydrogen chloride oxidation can be used in an advantageous manner for generation of high pressure steam. This can be used for operation of a phosgenation reactor and/or of distillation columns, in particular isocyanate distillation columns.

In a last step of the new process, the chlorine formed is separated off under generally known conditions. The separating step conventionally comprises several stages, namely separating, off and optionally recycling unreacted hydrogen chloride from the product gas stream of the catalytic hydrogen chloride oxidation, drying of the stream obtained, which essentially contains chlorine and oxygen, and separating off chlorine from the dried stream.

The separating of unreacted hydrogen chloride, and of the steam formed, can be carried out by condensing aqueous hydrochloric acid out of the product gas stream of the hydrogen chloride oxidation by cooling. Hydrogen chloride can also be absorbed into dilute hydrochloric, acid or water.

The invention will now be described in further detail with reference to the following non-limiting examples.

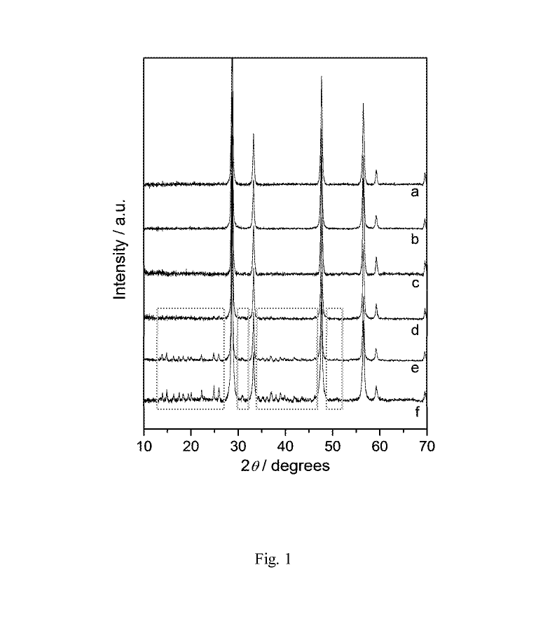

In the Examples FIG. 1 shows a phase analysis with XRD (Example 10)

### EXAMPLES

### Example 1

### (Invention): Supported Catalyst Preparation

A supported cerium oxide catalyst was prepared by: (1) Incipient wetness impregnation of an alumina carrier from Saint-Gobain Norpro (SA 6976, 1.5 mm, 254 m²/g) with an aqueous solution of commercial Cerium (III)chloride heptahydrate (Aldrich, 99.9 purity), followed by (2) drying at 80° C. for 6 h and (3) calcination at 700° C. for 2 h. The final load after calcination calculated as CeO₂ was 15.6 wt. % based on the total amount of catalyst.

### Example 2

### (Invention): Crushing of Supported Catalyst

The cerium oxide catalyst from example 1 was crushed to a sieve fraction (100 to 250 μm particle diameter).

### Example 3

### (Comparative O₂/HCl-Ratio): Short-Term Supported Catalyst Testing

1 g of the cerium oxide catalyst from example 1 as prepared was filled into a tube (8 mm inner diameter) for each experiment. The catalyst in the tube was heated up under nitrogen flow. After reaching steady conditions, a gas mixture of HCl and oxygen (table 1) was fed to the tube at 430° C. under approximately atmospheric pressure. By trace heating of the tube the temperature was kept constant at 430° C. Several times the product stream was passed through a sodium iodide solution (20 wt. % in water) for approximately 15 min and the thereby produced iodine was titrated with a 0.1 N thiosulfate-solution. The space time yield (STY) was calculated by using the following equation:

Space time yield [g/gh]=m_{Cl2}×m_{catalyst}⁻¹×t_{sampling}⁻¹

Wherein m_{Cl2} is the amount of chlorine, m_{catalyst} is the amount of catalyst which was used and t_{sampling} is the sampling time.

TABLE 1
Strong deactivation of a supported cerium oxide catalyst at a O₂/HCl-ratio <0.75

| HCl | O₂ | N₂ | O₂/HCl | STY | STY | STY | STY | STY | STY | STY |
|---|---|---|---|---|---|---|---|---|---|---|
| L/h | L/h | L/h | ratio | 1 h | 2 h | 3 h | 4 h | 6 h | 8 h | 24 h |
| 6 | 4 | 0 | 0.67 | 0.19 | 0.14 | 0.13 | 0.13 | 0.11 | 0.09 | 0.08 |

Evaluation: The supported cerium oxide catalyst from example 1 gets rapidly deactivated at an O₂/HCl-ratio below 0.75. Although the HCl partial pressure is high (compared to example 4), the equilibrated STY is very low.

### Example 4

### (Inventive O₂/HCl-Ratio): Short-Term Supported Catalyst Testing

1 g of the cerium oxide catalyst from example 1 was used for each experiment. The arrangement and the execution of the experiments were equal as in example 3, except that the gas flows were varied. Results are listed in table 2.

TABLE 2
Smooth equilibration of a supported cerium oxide
catalyst at an O₂/HCl-ratio >0.75

| HCl | O₂ | N₂ | O2/HCl | STY | STY | STY | STY | STY | STY | STY | STY |
|---|---|---|---|---|---|---|---|---|---|---|---|
| L/h | L/h | L/h | ratio | 1 h | 2 h | 3 h | 4 h | 6 h | 7 h | 23 h | 71 h |
| 1 | 4 | 5 | 4 | 0.43 | 0.40 | 0.39 | 0.38 | 0.37 | | 0.34 | |
| 2 | 4 | 4 | 2 | 0.66 | 0.59 | | 0.58 | 0.60 | 0.60 | | 0.58 |
| 2.29 | 4 | 3.71 | 1.75 | 0.61 | 0.60 | 0.61 | 0.61 | 0.63 | 0.62 | 0.58 | |
| 1.5 | 2 | 6.5 | 1.33 | 0.38 | 0.40 | 0.38 | 0.37 | 0.38 | 0.38 | 0.37 | |
| 2 | 2 | 6 | 1 | 0.39 | 0.35 | 0.33 | 0.31 | 0.3 | 0.27 | | |

Evaluation: Although the HCl partial pressure is 2.6 to 6 times lower (compared to example 3), the equilibrated activity under a sufficient O₂/HCl-ratio equal or above 0.75 is 3 to 6.5-times higher than under an insufficient O₂/HCl-ratio below 0.75. The initial deactivation during equilibration is also much less pronounced at a sufficient O₂/HCl-ratio equal or above 0.75.

### Example 5

### (Comparative O₂/HCl-Ratio): Short-Term Supported, Crushed Catalyst Testing

1 g of the sieve fraction (100 to 250 μm) from example 2 was diluted by 4 g of spheri glass and filled into a tube for each experiment. The catalyst in the tube was heated up under nitrogen flow. After reaching steady conditions, a gas mixture of HCl and oxygen as indicated in table 3 were fed to the tube at 400° C. under approximately atmospheric pressure. By trace heating of the tube the temperature was kept constant at 400° C. over the time on stream. Several times the product stream was passed through a sodium iodide solution (20 wt. % in water) and the thereby produced iodine was titrated with a 0.1 N thiosulfate-solution. The HCl-conversion was calculated by using the following equation:

HCl-conversion [%]=2×n_{Cl2}×n_{HCl}⁻¹×100%

Wherein n_{Cl2} is the titrated molar amount of chlorine and n_{HCl} is the fed molar amount of HCl in the same time period.

TABLE 3
Rapid deactivation of supported cerium oxide
catalysts at O₂/HCl-ratio <0.75

| | | | O₂/HCl | 5 | 10 | 15 | 20 | 30 | 40 |
|---|---|---|---|---|---|---|---|---|---|
| HCl³ | O₂³ | N₂³ | ratio | min | min | min | min | min | min |
| 1.32 | 0.88 | 1.32 | 0.67 | 6.3¹ | | 5.8¹ | 5.7¹ | 5.2¹ | 4.8¹ |
| 1.76 | 0.88 | 0.88 | 0.5 | 5.1¹ | 4.7¹ | 4.3¹ | 3.9¹ | 3.1¹ | |

¹HCl-conversion at x min.
³in mmol/min

Evaluation: At an O₂/HCl-ratio below 0.75 the HCl-conversion is at a very low level, with underlying strong deactivation trend.

### Example 6

### (Inventive O₂/HCl-Ratio): Short Term Support Crushed Catalyst Testing

1 g of a sieve fraction (100 to 250 μm) from example 2 was used. The arrangement and the execution of the experiments were equal as in example 4, except that the gas flows were varied (table 4),

TABLE 4
Smooth deactivation of supported cerium oxide catalysts at O₂/HCl-ratio >0.75

| | | | O₂/HCl | 5 | 10 | 15 | 20 | 30 | 40 |
|---|---|---|---|---|---|---|---|---|---|
| HCl³ | O₂³ | N₂³ | ratio | min | min | min | min | min | min |
| 1.10 | 0.88 | 1.54 | 0.8 | 9.5¹ | 9.5¹ | 9.3 | 9.1¹ | 8.7¹ | 8.5¹ |
| 0.88 | 0.88 | 1.76 | 1 | 12.1 | 11.9 | 11.8 | 11.6 | | |
| 0.66 | 0.88 | 1.98 | 1.33 | 15.7 | 15.6 | 15.3 | | | |
| 0.44 | 0.88 | 2.20 | 2 | 24.5 | 23.8 | 22.2 | 22.2 | | |
| 0.22 | 0.88 | 2.42 | 4 | 48.8 | 50.1 | 46.9 | 45.1 | | |

¹HCl-conversion at x min,
³in mmol/min

Evaluation: The higher the O₂/HCl-ratio is, the higher the HCl-conversion is. At an O₂/HCl-ratio equal or above 0.75 the deactivation is only minor

### Example 7

### (Inventive O₂/HCl-Ratio): Medium-Term Supported Catalyst Testing

1 g of the cerium oxide catalyst from example 1 as prepared was filled into a tube (8 mm inner diameter). The catalyst in the tube was heated up under nitrogen flow. After reaching steady conditions, 1 L/h HCl, 4 L/h O₂ and 5 L/h N₂ were fed to the tube at 430° C. under approximately atmospheric pressure. By trace heating of the tube the temperature was kept constant at 430° C. Several times the product stream was passed through a sodium iodide solution (20 wt. % in water) for approximately 15 min and the thereby produced iodine was titrated with 0.1 N thiosulfate-solution (table 5). The space time yield was calculated by using the following equation:

Space time yield [g/gh]=m_{Cl2}×m_{catalyst}⁻¹×t_{sampling}⁻¹

Wherein m_{Cl2} is the amount of chlorine, m_{catalyst} is the amount of catalyst which was used and t_{sampling} is the sampling time.

TABLE 5
Stable activity of a supported cerium oxide catalyst after equilibration

| | | | | | | | | |
|---|---|---|---|---|---|---|---|---|
| Time on | 16 | 23 | 88 | 161 | 185 | 255 | 308 | 448 |
| stream [h] | | | | | | | | |
| STY [g/gh] | 0.35 | 0.35 | 0.34 | 0.36 | 0.35 | 0.35 | 0.37 | 0.36 |

Evaluation: The activity of the supported cerium oxide catalyst from example 1 after equilibration (compare example 4) is very stable at an O₂/HCl-ratio equal or above 0.75.

### Example 8

### (Inventive O₂/HCl-Ratio): Long-Term Supported Catalyst Testing

80 g of the cerium oxide catalyst from example 1 as prepared were filled into a tube (14 mm inner diameter, 1.5 m length, including an inner tube with moveable thermocouple). The catalyst inside the tube was heated up under a preheated nitrogen flow. After reaching steady conditions, 0.3 mol/h HCl and 0.75 mol/h oxygen (O₂/HCl-ratio of 2.5) under approximately atmospheric pressure were fed to the tube. By pre-heating of the gas mixture and trace heating of the tube the temperature profile was kept approximately constant over 5005 h time on stream (table 6). Several times the product stream was passed through a sodium iodide solution (20 wt. % in water) for approximately 15 min and the thereby produced iodine was titrated with a 0.1 N thiosulfate-solution (table 7). The HCl-conversion was calculated by using the following equation:

HCl-conversion [%]=2×n_{Cl2}×n_{HCl}⁻¹×100%

Wherein n_{Cl2} is the titrated molar amount of chlorine and n_{HCl} is the fed molar amount of HCl in the same time period.

The process condensate (saturated hydrochloric acid at room temperature) was sampled three times: after 671 h, 1127 h and 3253 h time on stream. According to ICP-OES analysis the alumina content in the condensate was always below 2 wt. ppm (671 h, 1127 h) and even below 0.5 wt. ppm after 3253 h. The cerium content in the condensate was always similar or below 0.3 wt. ppm!

TABLE 6
Temperature profile (+/− 2K for each taken point)

| position | inlet | +2 cm | +4 cm | +6 cm | +8 cm | +10 cm |
|---|---|---|---|---|---|---|
| T [° C.] | 397 | 400 | 403 | 404 | 405 | 404 |
| position | +12 cm | +14 cm | +16 cm | +18 cm | +20 cm | +22 cm |
| T [° C.] | 403 | 402 | 401 | 400 | 401 | 402 |
| position | +24 cm | +26 cm | +28 cm | +30 cm | +32 cm | +34 cm |
| T [° C.] | 407 | 412 | 418 | 425 | 432 | 437 |
| position | +36 cm | +38 cm | +40 cm | +42 cm | +44 cm | +46 cm |
| T [° C.] | 441 | 443 | 445 | 446 | 447 | 447 |
| position | +48 cm | +50 cm | +52 cm | +54 cm | +56 cm | +58 cm |
| T [° C.] | 448 | 449 | 449 | 449 | 449 | 450 |
| position | +60 cm | +62 cm | +64 cm | +66 cm | +68 cm | +70 cm |
| T [° C.] | 450 | 450 | 450 | 450 | 449 | 449 |
| position | +72 cm | +74 cm | +76 cm | +78 cm | +80 cm | +82 cm |
| T [° C.] | 448 | 449 | 450 | 453 | 455 | 457 |
| position | +84 cm | +86 cm | +88 cm | +90 cm | +92 cm | +94 cm |
| T [° C.] | 458 | 458 | 459 | 459 | 458 | 456 |
| position | +96 cm | +98 cm | outlet | | | |
| T [° C.] | 454 | 450 | 445 | | | |

TABLE 7
Long-term stable activity of a supported cerium oxide catalyst

| | | | | | | | | | |
|---|---|---|---|---|---|---|---|---|---|
| Time on stream [h] | 551 | 1055 | 1535 | 2039 | 2509 | 3085 | 3661 | 4141 | 5005 |
| HCl-conversion [%] | 41.0 | 39.2 | 38.5 | 38.4 | 38.8 | 37.9 | 37.4 | 38.3 | 36.9 |

Evaluation: At an O₂/HCl-ratio of 2.5 only a very minor deactivation is observable over 5005 h time on stream! Based on condensate analysis the estimated percentage loss of cerium and alumina is below 0.1% over 5005 h time on stream. Consequently the loss of catalyst constituents is negligible, which is a further proof for catalyst stability.

### Example 9

### (Inventive and Comparative O₂/HCl-Ratio): Short-Term Unsupported Catalyst Testing

Cerium oxide powder (Aldrich, nanopowder) was calcined at 900° C. for 5 h. For each experiment 0.5 g of the calcined sample (particle size=0.4 to 0.6 mm) was filled into a tube (8 mm inner diameter). The catalyst powder inside the tube was heated up under nitrogen flow. After reaching steady conditions, HCl, O₂ and N₂ were fed under approximately atmospheric pressure to the tube. By trace heating of the tube the catalyst temperature was kept constant at 430° C. The O₂/HCl ratio was varied between 0.5 and 7, keeping the partial pressure of HCl constant, and between 0.25 and 2, keeping the oxygen partial pressure constant. After 1 h time on stream in each O₂/HCl ratio the outlet gas was passed through a sodium iodide solution (2 wt. % in water) for approximately 5 min and the thereby produced iodine was titrated with 0.1 M sodium thiosulfate solution. The HCl-conversion was calculated by using the following equation:

HCl-conversion [%]=2×n_{Cl2}×n_{HCl}⁻¹×100%

Wherein n_{Cl2} is the titrated molar amount of chlorine and n_{HCl} is the fed molar amount of HCl in the same time period.

TABLE 8
Dependency of (nearly equilibrated) HCl-conversion on O₂/HCl-ratio

| Experiment | a | b | c | d | e | f | g | h | i | j | k |
|---|---|---|---|---|---|---|---|---|---|---|---|
| HCl [%] | 10 | 10 | 10 | 10 | 10 | 10 | 40 | 30 | 20 | 10 | 5 |
| O₂ [%] | 5 | 10 | 20 | 30 | 40 | 70 | 10 | 10 | 10 | 10 | 10 |
| N₂ [%] | 85 | 80 | 70 | 60 | 50 | 20 | 50 | 60 | 70 | 80 | 85 |
| O₂/HCl | 0.5 | 1 | 2 | 3 | 4 | 7 | 0.25 | 0.33 | 0.5 | 1 | 2 |
| HCl-conversion [%] | 8.8 | 12.1 | 16.6 | 18.7 | 21.6 | 26.3 | 1.0 | 2.3 | 7.1 | 14.5 | 22.9 |

Evaluation: An increase of the O₂/HCl ratio appears beneficial to achieve higher conversion levels in the low O₂/HCl-ratio range. In particular, an increase of the O₂/HCl-ratio from 0.25 to 0.5 (g-h-i) improves the HCl-conversion by a factor of 7, while an increase of the O₂/HCl-ratio from 1 to 7 improves the HCl-conversion only by a factor of 2. Consequently, at O₂/HCl ratios below 0.75 the process economics can be dramatically optimized by increasing the O₂/HCl-ratio, whereas at O₂/HCl-ratios equal or above 0.75 one has to balance surplus oxygen costs (running) against catalyst costs (one time). Consequently, experiments b to f and j to k are recognized as according to the invention, whereas experiments a and g to i are considered as comparative examples.

Note that the equilibration of an unsupported cerium oxide powder catalyst is assumed to be much faster than the equilibration of a supported, pelletized catalyst. The observed HCl-conversion is accordingly treated as nearly equilibrated. Longer equilibration times would have resulted in substantially identical HCl-conversion levels for O₂/HCl-ratios equal or above 0.75, but in even lower activity levels for O₂/HCl-ratios below 0.75, shown to lead to deactivation. This point is further detailed in Example 12.

### Example 10

### (Scientific Prove): Catalyst Characterization by XRD

X-Ray diffraction phase analysis (PAN analytical X'Pert PRO-MPD diffractometer, 10 to 70° 2θ range, angular step size of 0.017° and a counting time of 0.26 s per step; FIG. 1 shows a Phase analysis with XRD, patterns a to f) was applied to characterize cerium oxide samples (Aldrich, nanopowder) treated in different conditions, namely, calcined at 900° C. (a) and exposed at 430° C. for 3 h respectively to a reaction mixture with O₂/HCl-ratios of 0 (e), or 0.25 (d), or 0.75 (c) or 2 (b) or calcined at 500° C. and treated at 430° C. and 3 h in a feed with O₂/HCl-ratio of 0 (f). CeO₂ (JCPDS 73-6328) is evidenced as exclusive or dominant phase in the XRD patterns. Reflections of CeCl₃.6H₂O (JCPDS 01-0149) appear in the 20 ranges marked by the gray boxes for some of the diffractograms.

Evaluation: After treatment of the cerium oxide sample calcined at 900° C. in a feed with an O₂/HCl-ratio of 2 the XRD pattern (b) only shows the characteristic reflexions of CeO₂. After treatment of cerium oxide calcined at 900° C. in a feed with O₂/HCl-ratios of 0 or 0.25 reflexions specific to CeCl₃.6H₂O are as well evidenced in appreciable intensity. After treatment of cerium oxide calcined at 900° C. in a feed with an O₂/HCl-ratio of 0.75 the diffractogram only shows the characteristic reflexions of CeO₂. Diffraction lines specific to CeCl₃.6H₂O, if present, are not distinguishable from the noise. The XRD pattern of the cerium oxide sample calcined at 500° C. and treated in a feed with O₂/HCl ratio of 0 evidences the presence of CeCl₃.6H₂O and in higher amount with respect to the cerium oxide sample calcined at 900° C. and similarly treated. Consequently, we believe that the deactivation of the cerium oxide catalyst, observed at O₂/HCl-ratios below 0.75, is caused by the formation of the CeCl₃.6H₂O phase, which is much less active in HCl-oxidation than CeO₂ (see also Example 11). Furthermore, calcination of cerium oxide at higher temperatures (900° C.) seems to result in a catalyst better resistant to chlorination.

### Example 11

### (Scientific Prove): Catalyst Characterization by BET/XPS

Cerium oxide powder (Aldrich, nanopowder) was calcined at 500° C. and 900° C. for 5 h (table 9) and from 300° C. to 1100° C. for 5 h respectively (table 10), The calcined catalyst samples were further treated in O₂/HCl=2 at 430° C. for 3 h (label O₂/HCl=2 in table 9, table 10) or in O₂/HCl=0 at 430° C. for 3 h (label O₂/HCl=0 in table 9). The fresh samples (table 10) and the treated samples (table 9) were analyzed by nitrogen adsorption to measure their surface area (Quantachrome Quadrasorb-SI gas adsorption analyzer, BET-method) and X-ray photoelectron spectroscopy to assess the degree of surface chlorination (Phoibos 150, SPECS, non-monochromatized A1 Kα (1486.6 eV) excitation, hemispherical analyzer).

TABLE 9
Surface area and chlorination of the catalyst evaluated by XPS

| pretreatment | BET m²/g | Cl/Ce-stoichiometry | theoretical layers |
|---|---|---|---|
| 1173 K, O₂/HCl = 2 | 25 | 0.14 | 1.0¹ |
| 1173 K, O₂/HCl = 0 | 25 | 0.29 | 2.4¹ |
| 773 K, O₂/HCl = 2 | 27 | 0.19 | 1.5¹ |
| 773 K, O₂/HCl = 0 | 27 | 0.55 | 5.7¹ |

¹Calculated by model IMFP with inelastic mean free path of 22 Angström (by TPP-2M)

TABLE 10
Dependency of HCl-conversion on calcination temperature

| Calcination temperature | 573 K | 773 K | 1023 K | 1173 K | 1273 K | 1373 K |
|---|---|---|---|---|---|---|
| Surface area [m²/g] | 117 | 106 | 53 | 30 | 12 | 1 |
| HCl-conversion | 29 | 25 | 25 | 27 | 14 | 2 |

Evaluation: For the unsupported cerium oxide powder sample pre-calcined at 500° C. and treated with an O₂/HCl-ratio of 2, only 1 to 2 theoretical layer of oxygen are exchanged by chlorine (some of the detected chlorine could also be related to adsorbed chlorine on the catalyst surface), whereas after a treatment with an O₂/HCl-ratio of 0, 5 to 6 theoretical layer of oxygen are exchanged by chlorine. The cerium oxide samples pre-calcined at 900° C. exhibit a similar but very less pronounced effect (1 theoretical layer versus 2 to 3 theoretical layers). The results are in line with the bulk chlorination detected by XRD analysis (Example 10), confirming the postulated relationship between deactivation and CeCl₃.6H₂O phase formation. Calcination of cerium oxide at temperatures in the range of 300 to 1100° C. produces materials with different initial surface areas (decreasing with increasing calcination temperature, table 10). Contrarily, the surface area values of the samples calcined at 500° C. drops significantly after treatment either in O₂/HCl=2 or 0 while that of the sample calcined at 900° C. and equally treated is changed to minor extent (table 9). Thus, calcination at higher temperature is beneficial to obtain a stabilized catalyst and is the feasible origin of the higher resistance towards chlorination shown by XRD (Example 10) and XPS.

### Example 12

### (Invention): Catalyst Regeneration

Cerium oxide powder (Aldrich, nanopowder) was calcined at 900° C. for 5 h. For each experiment 0.5 g of the calcined powder was filled into a tube (8 mm inner diameter). The catalyst powder inside the tube was heated up under nitrogen flow. After reaching steady conditions, experiments were carried out at 430° C. combining a deactivation step, in which the catalyst was exposed to a not inventive feed composition O₂/HCl=0 (3 h) or 0.25 (5 h), and a regeneration step (inventive), in which excess of oxygen was fed (O₂/HCl=2 or 7) for 2 h in order to study the reoxidation of the catalyst.

TABLE 11
Deactivation followed by regeneration experiments over unsupported CeO₂

| Experiment 1 | Deactivation | | | | | | Regeneration | | | |
|---|---|---|---|---|---|---|---|---|---|---|
| | HCl [%] | | O₂ [%] | N₂ [%] | | O₂/HCl | HCl [%] | O₂ [%] | N₂ [%] | O₂/HCl |
| Conditions^{a} | 10 | | 2.5 | 87.5 | | 0.25 | 10 | 20 | 70 | 2 |
| Time-on- | 0.25 | 1 | 2 | 3 | 4 | 5 | 5.25 | 5.5 | 6 | 7 |
| stream [h] | | | | | | | | | | |
| HCl-conver- | 5.9 | 5 | 4.6 | 4.1 | 3.8 | 3.7 | 13.4 | 15.0 | 15.9 | 16.4 |
| sion [%] | | | | | | | | | | |
| Experiment 2 | Deactivation | | | | | | Regeneration | | | |
| | HCl [%] | | O₂ [%] | N₂ [%] | | O₂/HCl | HCl [%] | O₂ [%] | N₂ [%] | O₂/HCl |
| Conditions | 10 | | 2.5 | 87.5 | | 0.25 | 10 | 70 | 20 | 7 |
| Time-on- | 0.25 | 1 | 2 | 3 | 4 | 5 | 5.25 | 5.5 | 6 | 7 |
| stream [h] | | | | | | | | | | |
| HCl-conver- | 5.4 | 5 | 4.8 | 4.4 | 4.3 | 4 | 28.1 | 28.2 | 27.8 | 26.8 |

| sion [%] | | | | | | | | | |
|---|---|---|---|---|---|---|---|---|---|
| Experiment 3 | Deactivation | | | | | Regeneration | | | |
| | HCl [%] | | O₂ [%] | N₂ [%] | O₂/HCl | HCl [%] | O₂ [%] | N₂ [%] | O₂/HCl |
| Conditions | 10 | | 0 | 90 | 0 | 10 | 70 | 20 | 7 |
| Time-on- | 0.17 | 0.5 | 1 | 2 | 3 | 3.17 | 3.5 | 4 | 5 |
| stream [h] | | | | | | | | | |
| HCl-conver- | 1.2 | 0.9 | 0.7 | 0.2 | 0 | 9.5 | 29.7 | 30.3 | 29.1 |

sion [%]

Evaluation: A progressive decrease in activity is observed with O₂/HCl=0.25 (table 11, experiment 1). Upon increasing the O₂ content in the feed (O₂/HCl=2), the activity is slowly restored. However, the activity level expected for the O₂/HCl=2 feed composition (HCl conversion=22%, Example 9) is not completely reached within 2 h. Regeneration with O₂/HCl=7 is on the other hand extremely fast (table 11, experiment 2). This evidence supports chlorination of the catalyst (Example 10) in the deactivation phase and fast chlorine displacement by excess oxygen.

When performing the deactivation phase in O₂/HCl=0 (table 11, experiment 3) the catalyst activity is logically completely lost in 3 h. In Example 10 it is shown that cerium oxides indeed chlorinated to larger extent in the presence of the sole HCl. Still, regeneration in O₂/HCl=7 fully restores the original activity in 1 h.

### Example 13

### (Invention): Design Example of a Tube Bundle Reactor with a Cerium Oxide Catalyst

As feed streams 9.30 mmol/s HCl, 9.30 mmol/s O₂, 0.32 mmol/s Cl₂, 0.59 mmol/s H₂O and 3.75 mmol/s N₂ are provided at approximately 4 bar (gauge) to one tube of 4 m length (0.021 m diameter) of an isothermal tube bundle reactor. The tube is filled from 0.1 to 4.0 m with a cerium oxide catalyst according to example 1. The temperature of the heat transfer medium in reaction zone 1 (0.1 to 2.0 m) is 400° C., the temperature of the heat transfer medium in reaction zone 2 (2.0 to 4.0 m) is 420° C. The heat transfer coefficient lambda is assumed to be 0.018 Wm⁻¹K⁻¹. The average temperature of the catalyst bed at the indicated position is provided in table 12 (temperature profile in the direction of flow), The HCl-conversion is 53% after 1 m, 69% after 2 m, 80% after 3 m and 87% after 4 m.

The minimal O₂/HCl-ratio is 1 for the inlet of the tube bundle reactor. Note that the minimal O₂/HCl-ratio is at the inlet of a catalyst bed due to the reaction stoichiometry (4 moles of HCl converted per mol of oxygen).

TABLE 12
Temperature profile of a tube bundle reactor with a
cerium oxide catalyst

| position | T |
|---|---|
| [m] | [° C.] |
| 0.1 | 400.0 |
| 0.2 | 427.8 |
| 0.3 | 415.9 |
| 0.4 | 411.1 |
| 0.5 | 408.7 |
| 0.6 | 407.3 |
| 0.7 | 406.4 |
| 0.8 | 405.6 |
| 0.9 | 405.0 |
| 1.0 | 404.6 |
| 1.1 | 404.1 |
| 1.2 | 403.8 |
| 1.3 | 403.5 |
| 1.4 | 403.3 |
| 1.5 | 403.0 |
| 1.6 | 402.8 |
| 1.7 | 402.7 |
| 1.8 | 402.5 |
| 1.9 | 402.4 |
| 2.0 | 402.2 |
| 2.1 | 419.6 |
| 2.2 | 422.1 |
| 2.3 | 422.2 |
| 2.4 | 422.1 |
| 2.5 | 422.0 |
| 2.6 | 421.8 |
| 2.7 | 421.7 |
| 2.8 | 421.7 |
| 2.9 | 421.6 |
| 3.0 | 421.5 |
| 3.1 | 421.4 |
| 3.2 | 421.3 |
| 3.3 | 421.3 |
| 3.4 | 421.2 |
| 3.5 | 421.2 |
| 3.6 | 421.1 |
| 3.7 | 421.0 |
| 3.8 | 421.0 |
| 3.9 | 421.0 |
| 4.0 | 420.9 |

### Example 14

### (Invention): Design Example of a Tube Bundle reactor with a Combination of a Cerium Oxide Catalyst and a Ruthenium Based Catalyst

As feed streams 9.30 mmol/s HCl, 9.30 mmol/s O₂, 0.32 mmol/s Cl₂, 0.59 mmol/s H₂O and 3.75 mmol/s N₂ are provided at approximately 4 bar (gauge) to one tube of 4 m length (0.021 m diameter) of an isothermal tube bundle reactor. The tube is filled from 0.1 to 3.0 m with a cerium oxide catalyst according to example 1 and from 3.0 to 4.0 m with a supported ruthenium catalyst according to EP 2027062. The temperature of the heat transfer medium in reaction zone 1 (0.1 to 3.0 m) is 400° C., the temperature of the heat transfer medium in reaction zone 2 (3.0 to 4.0 m) is 360° C. The heat transfer coefficient lambda is assumed to be 0.018 Wm⁻¹K⁻¹. The average temperature of the catalyst bed at the indicated position is provided in table 13 (temperature profile in the direction of flow). The HCl-conversion is 53% after 1 m, 69% after 2 m, 79% after 3 m and 87% after 4 m.

The minimal O₂/HCl-ratio is 1 for the inlet of the tube bundle reactor. Note that the minimal O₂/HCl-ratio is at the inlet of a catalyst bed due to the reaction stoichiometry (4 moles of HCl converted per mol of oxygen).

TABLE 13
Temperature profile of a tube bundle reactor with a
combination of a cerium oxide catalyst and a ruthenium based catalyst

| position | T |
|---|---|
| [m] | [° C.] |
| 0.1 | 400.0 |
| 0.2 | 427.8 |
| 0.3 | 415.9 |
| 0.4 | 411.1 |
| 0.5 | 408.7 |
| 0.6 | 407.3 |
| 0.7 | 406.4 |
| 0.8 | 405.6 |
| 0.9 | 405.0 |
| 1.0 | 404.6 |
| 1.1 | 404.1 |
| 1.2 | 403.8 |
| 1.3 | 403.5 |
| 1.4 | 403.3 |
| 1.5 | 403.0 |
| 1.6 | 402.8 |
| 1.7 | 402.7 |
| 1.8 | 402.5 |
| 1.9 | 402.4 |
| 2.0 | 402.2 |
| 2.1 | 402.1 |
| 2.2 | 402.0 |
| 2.3 | 401.9 |
| 2.4 | 401.8 |
| 2.5 | 401.7 |
| 2.6 | 401.6 |
| 2.7 | 401.6 |
| 2.8 | 401.5 |
| 2.9 | 401.4 |
| 3.0 | 401.4 |
| 3.1 | 365.5 |
| 3.2 | 362.0 |
| 3.3 | 361.6 |
| 3.4 | 361.5 |
| 3.5 | 361.4 |
| 3.6 | 361.3 |
| 3.7 | 361.3 |
| 3.8 | 361.2 |
| 3.9 | 361.1 |
| 4.0 | 361.1 |

### Example 15

### (Inventive O₂/HCl-Ratio): Supported Catalyst Testing at 4 Bar (Gauge)

25 g of the cerium oxide catalyst from example 1 as prepared were filled into a tube (21 mm inner diameter, 330 mm length, including an inner tube with moveable thermocouple). The catalyst inside the tube was heated up under a preheated nitrogen flow. After reaching steady conditions, varying gas feeds under approximately 4 bar (gauge) were fed to the tube (table 14). Two times (after 60 min and 120 min) the product stream was passed through a sodium iodide solution (20 wt. % in water) and the thereby produced iodine was titrated with a 0.1 N thiosulfate-solution (table 7). The space time yield (STY) was calculated by using the following equation:

Space time yield [g/gh]=m_{Cl2}×m_{catalyst}⁻¹×t_{sampling}⁻¹

Wherein n_{Cl2} is the amount of chlorine, m_{catalyst} is the amount of catalyst which was used and t_{sampling} is the sampling time. In table 14 the average value of the two titrations is given.

TABLE 14
STY of cerium oxide catalyst at elevated
pressure and an O₂/HCl-ratio > 0.75

| HCl | O₂ | N₂ | T | O₂/HCl | STY |
|---|---|---|---|---|---|
| [L/h] | [L/h] | [L/h] | [° C.] | ratio | [g/gh] |
| 40 | 100 | 360 | 276 | 2.5 | 0.78 |
| 40 | 100 | 360 | 400 | 2.5 | 1.21 |

Evaluation: At an O₂/HCl-ratio of 2.5 and elevated pressure the cerium oxide catalyst exhibits a sufficient activity at 276° C. and at 400° C.

1. A process for the production of chlorine by thermo-catalytic gas phase oxidation of hydrogen chloride gas with oxygen, in the presence of a catalyst, and separation of the chlorine from the reaction products comprising chlorine, hydrogen chloride, oxygen and water,
wherein
a) a cerium oxide is used as catalytically active component in the catalyst and
b) the reaction gases are converted at the cerium oxide catalyst in one or more isothermic reaction zones, optionally in one or more tube bundle reactors,
the molar O₂/HCl-ratio is equal or above 0.75 in any part of the cerium oxide containing reaction zones.

2. Process according to claim 1, wherein only a single isothermal reactor is used in the process.

3. Process according to claim 1, wherein the isothermic reactors comprise at least two different reaction zones, which are connected in series.

4. Process according to claim 3, wherein different reaction zones are provided which are operated at a different reaction temperature.

5. Process according to claim 3, wherein the different reaction zones are operated using catalyst material having a different catalyst activity in different reaction zones.

6. Process according to claim 1, wherein the different reaction zones are operated using catalyst material having different catalysts with different catalytically active components in the catalyst.

7. Process according to claim 1, wherein the average temperature in all cerium oxide catalyst containing reaction zones is kept in the range of from 300 to 600° C.

8. Process according to claim 1, wherein the outlet reaction gas temperature in the last reaction zone is kept at equal or below 450° C.

9. Process according to claim 1, wherein a catalyst is used comprising ruthenium metal and/or ruthenium compounds and cerium oxide as catalytically active components.

10. Process according to claim 1, wherein at least two different types of catalysts are present in different reaction zones, wherein a first type of catalyst comprises ruthenium metal and/or ruthenium compounds as catalytically active component and a second type of catalyst comprises cerium oxide as catalytically active component.

11. Process according to claim 10, wherein the ruthenium-based catalyst is applied in a reaction zone which is kept at a gas temperature in the range of from 200 to 450° C., and the cerium oxide catalyst is applied in a reaction zone which is kept at a gas temperature in the range of from 300 to 600° C.

12. Process according to claim 1, wherein different reaction zones connected in series are used for the reaction, at least one reaction zone comprises a cerium oxide based catalyst and at least the last reaction zone comprises a ruthenium-based catalyst.

13. Process according to claim 1, wherein during operation of the process the initial activity of the cerium oxide catalyst is restored by raising the ratio of O₂/HCl and keeping the raised ratio of O₂/HCl for a period of about at least half an hour and then returning to the previous ratio of O₂/HCl.

14. Process according to claim 1, wherein a cerium oxide catalyst is applied which has been heated up during its preparation to a temperature of 500° C. to 1100° C.

15. Process according to claim 1, wherein a cerium oxide catalyst is used in the process which comprises no CeCl₃.6H₂O or CeCl₃ phases, and which does not exhibit significant X-ray diffraction reflections which are characteristic for CeCl₃.6H₂O or CeCl₃ phases.

16. Process according to claim 1, wherein the cerium oxide catalyst used in the process is subjected to an activity restoring treatment at increased molar O₂/HCl-ratio or replaced by fresh catalyst if more than 3 theoretical layers of oxygen in the cerium oxide catalyst are exchanged by chlorine during use of the catalyst.

17. Process according to claim 1, wherein the cerium oxide catalyst is a supported catalyst, supported by one or more support materials selected from the group consisting of silicon dioxide, aluminum oxide, titanium oxide, tin oxide and zirconium oxide.
